(19) United States
(12) Patent Application Publication
(10) Pub. No.: US 2025/0035324 A1
(43) Pub. Date: Jan. 30, 2025

(54) SYSTEMS AND METHODS FOR AIR CONDITIONER SUBCOOLING

(71) Applicant: Rheem Manufacturing Company, Atlanta, GA (US)

(72) Inventor: Geethakrishnan Vasudevan, Sugar Land, TX (US)

(21) Appl. No.: 18/753,245

(22) Filed: Jun. 25, 2024

Related U.S. Application Data
(60) Provisional application No. 63/515,418, filed on Jul. 25, 2023.

(51) Int. Cl. F24F 1/42; F24F 1/022; F24F 13/20; F24F 13/22

(52) U.S. Cl. CPC F24F 1/42; F24F 1/022; F24F 13/20; F24F 13/222

(57) ABSTRACT

An air conditioning system includes a condenser configured to condense gaseous refrigerant into liquid refrigerant. A sub-cooling conduit may be fluidically coupled to the condenser and configured to receive and sub-cool the liquid refrigerant. A base pan may collect condensate formed from ambient moisture. A condenser fan may blow air in a flow direction toward the condenser. The condenser fan may be positioned relative to the base pan to cause the condenser fan to direct a volume of condensate from the base pan onto the sub-cooling conduit. A method of sub-cooling refrigerant for air conditioning may include condensing refrigerant, and collecting condensate formed from ambient moisture in a base pan. The method may further include directing a volume of condensate from the base pan onto a sub-cooling conduit fluidically coupled to the condenser, and sub-cooling condensed liquid refrigerant in the sub-cooling conduit.

### CROSS-REFERENCE TO RELATED APPLICATIONS

This application claims priority to and the benefit of U.S. provisional application No. 63/515,418, filed Jul. 25, 2023, which is hereby incorporated by reference herein in its entirety.

### FIELD

The present disclosure generally relates to heating, ventilation, and air conditioning and more particularly relates to systems and methods for sub-cooling in air conditioner systems.

### BACKGROUND

Air conditioning systems may include stand-alone room air conditioners or split heating, ventilation, and air conditioning (HVAC) systems. Air conditioning systems extract and transfer heat from an interior space to an external environment by operating a vapor compression cycle including liquefying and evaporating refrigerant. A condenser is used to condense gaseous refrigerant into liquid refrigerant, which in turn is expanded in an expansion valve back into gaseous refrigerant and then provided to an evaporation coil. The expansion results in a cooling of the refrigerant flowing through the evaporation coil, which in turn is used to cool down air from the interior space blown onto and over the evaporation coil. In process of cooling, the gaseous refrigerant extracts heat from the air and is compressed in a compressor into hot gaseous refrigerant. This gaseous refrigerant is sent back to the condenser to repeat the cycle, where the heat is expelled from the gas to the external environment by air blown onto and over the condenser, for example, by a condenser fan. In this way, heat is ultimately transferred from the interior space into the circulating refrigerant and from the refrigerant to the external environment.

Sub-cooling (cooling to a temperature lower than a boiling point) may be used to further cool the liquid refrigerant condensed in the condenser, for example, before expansion in the evaporator. Such sub-cooling may improve the efficiency of cooling the air by making relatively colder refrigerant available in the evaporation coil, which is able to extract and transfer a relatively greater amount of heat.

A need remains for improving overall cooling efficiency in air conditioning systems.

### SUMMARY

The present disclosure describes systems and methods for sub-cooling in an air conditioner systems.

In embodiments, the present disclosure describes an air conditioning system. The system includes a condenser configured to condense gaseous refrigerant into liquid refrigerant. The system further includes a sub-cooling conduit fluidically coupled to the condenser and configured to receive and sub-cool the liquid refrigerant. The system further includes a base pan configured to collect external condensate formed from ambient moisture. The system further includes a condenser fan configured to blow air in a flow direction toward the condenser. The condenser fan is positioned relative to the base pan to cause the condenser fan to direct a volume of condensate from the base pan onto the sub-cooling conduit.

In embodiments, the present disclosure describes a method of sub-cooling refrigerant for air conditioning. The method includes condensing, in a condenser, gaseous refrigerant into liquid refrigerant. The method further includes collecting external condensate formed from ambient moisture in a base pan. The method further includes directing, by a condenser fan, a volume of condensate from the base pan onto a sub-cooling conduit fluidically coupled to the condenser. The method further includes sub-cooling the liquid refrigerant in the sub-cooling conduit.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1A is an upper perspective view of an air conditioning system including a condenser, a sub-cooling conduit, a base pan, and a condenser fan in accordance with one or more embodiments of the present disclosure.

FIG. 1B is a front view of selected components of the air conditioning system of FIG. 1A in accordance with one or more embodiments of the present disclosure.

FIG. 1C is a partial top view of selected components of the air conditioning system of FIG. 1A in accordance with one or more embodiments of the present disclosure.

The present disclosure provides a more detailed and specific description with reference to the accompanying drawings. The drawings and specific descriptions of the drawings, as well as any specific or other embodiments discussed, are intended to be read in conjunction with the entirety of this disclosure.

### DETAILED DESCRIPTION

Example embodiments will now be described more fully hereinafter with reference to the accompanying drawings, in which example embodiments are shown. The concepts disclosed herein may, however, be embodied in many different forms and should not be construed as limited to the example embodiments set forth herein; rather, these embodiments are provided so that this disclosure will be thorough and complete, and will fully convey the scope of the concepts to those skilled in the art. Like numbers refer to like, but not necessarily the same or identical elements throughout.

An air conditioning system may move external condensate (moisture) from an indoor side (for example, from an evaporator) to an outdoor side (for example, toward a condenser), and the condensate water may be utilized for more additional sub-cooling of the refrigerant in the condenser and/or an associated sub-cooling unit. External condensate may refer to moisture formed on the outer surfaces of the heat exchangers (e.g., evaporator and/or condenser) and/or moisture collected in a base pan or the like. In some instances, cold condensate water may be splashed using a slinger attached to the fan. The fan slinger may dip into the water in a base pan, pick it up, and sling to the side of the housing. The velocity with which the water is slung to the side may be high, in view of a high rotational speed of the condenser fan. The water may hit a sidewall and partially get atomized and carried away with the air stream, while some water may impinge directly on to the condenser coil. To sub-cool refrigerant, a liquid line from the condenser may be submerged inside the condensate. The liquid line may include bare copper tube. Such heat transfer between warm refrigerant and the cold condensate water is typically purely due to free convection between the water in the base pan and the refrigerant inside the liquid line.

Systems and methods according to the present disclosure may provide increased sub-cooling of liquid refrigerant discharged from a condenser coil. If more sub-cooling is accomplished outside the main condenser, more of the surface area of the condenser can used for two-phase condensation. Further, higher sub-cooling can reduce the mass flow rate required for a unit (ton) of air conditioning thus lower the required compressor power and increasing efficiency. A sub-cooling coil may be positioned (for example, vertically) against or near a sidewall and in the path of the water that is being forcefully slung by the condenser fan or by a slinger ring. Such water that is slung splashes onto the sub-cooling coil, providing a form of forced convection heat transfer between liquid refrigerant and the external condensate. Such a forced convection may enhance the heat transfer and reduce the liquid temperature and increase sub-cooling.

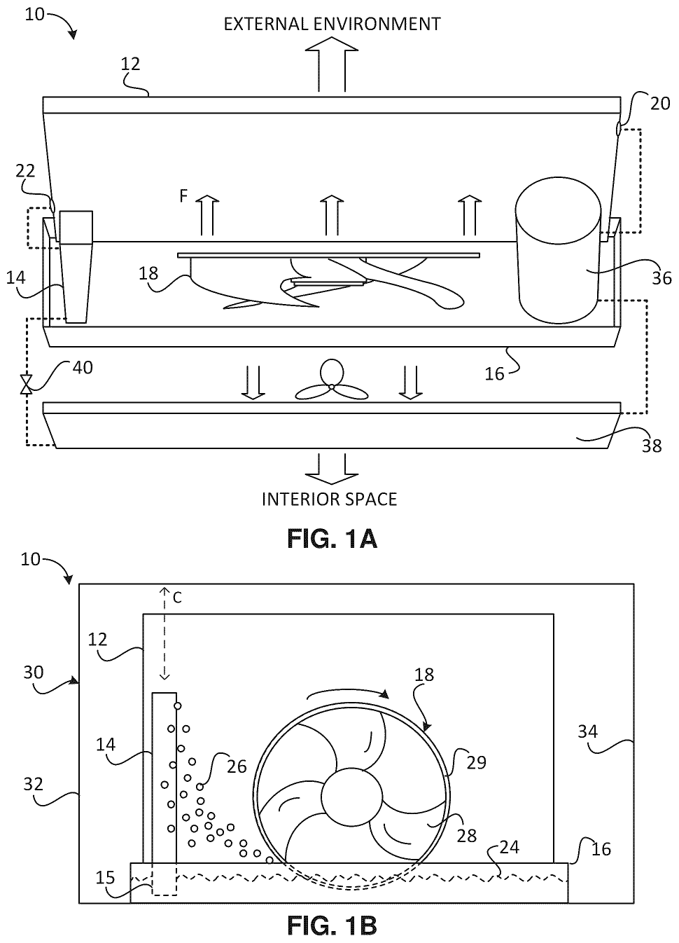

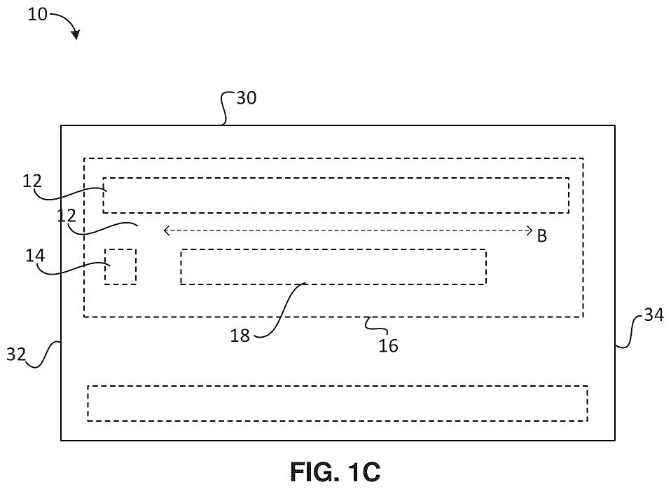

Turning now to the drawings, FIG. 1A is an upper perspective view of an air conditioning system 10. The air conditioning system 10 includes a condenser 12, a sub-cooling conduit 14, a base pan 16, and a condenser fan 18. FIG. 1B is a partial front view of the air conditioning system 10 of FIG. 1A. FIG. 1C is a partial top view of selected components of the air conditioning system 10 of FIG. 1A.

In certain embodiments, a refrigerant (not shown in FIGS. 1A and 1B) circulates through the various components of the air conditioning system 10. Any suitable refrigerant may be used herein. At different stages, the refrigerant may be in a liquid or gaseous state, as discussed with reference to various components of the air conditioning system 10. In this manner, the refrigerant may cycle through a vapor compression cycle as it circulates through the various components of the air conditioning system 10.

For example, the condenser 12 may have a condenser inlet 20 to receive a gaseous refrigerant. The condenser 12 may also include a condenser outlet 22 to dispense condensed (liquid) refrigerant. The condenser 12 is configured to condense gaseous refrigerant (for example, received through condenser inlet 12) into liquid refrigerant (for example, discharged at condenser outlet 22). During the process of condensation, the condenser fan 18 blows air in a flow direction (F) toward the condenser 12. Blowing the air through the condenser 12 promotes the transfer of heat from the gaseous refrigerant (flowing through the condenser 12) to an external environment (e.g., outside of a structure, such as a home) and promotes the cooling and condensing of the gaseous refrigerant into a liquid refrigerant as the refrigerant internally flows through the condenser 12 from the inlet 20 to the outlet 22.

To promote condensation, the condenser 12 may including undulating turns of tubing to provide a sufficiently long path for cooling the gaseous refrigerant and to further remove heat from the refrigerant to induce condensation. The condenser 12 may further include fins or other heat-dissipating features to increase surface area and promote heat transfer and condensation of the refrigerant and for heat dissipation to the external environment. The condenser 12 may include tubing in a housing or supported by a frame, or without a separate housing or frame, where the tubing itself may be formed into a self-supporting structure. The tubing may include or be formed of any suitable material, such as a metal or an alloy.

The sub-cooling conduit 14 is fluidically coupled to the condenser 12 and is configured to receive and sub-cool the liquid refrigerant. For example, an inlet of the sub-cooling conduit 14 is fluidically coupled (for example, by tubing) to the outlet 22 to receive the liquid refrigerant condensed in the condenser 12. In the course of condensing, the liquid refrigerant typically may cool to a temperature equal to or somewhat lower than a boiling point (or a condensation point) of the refrigerant. Certain air conditioning systems may circulate the liquid refrigerant as dispensed by the condenser 12 (at the temperature equal to or somewhat lower than the boiling point) to expansion valve and an evaporator for expansion into gaseous refrigerant to continue the air conditioning cycle. However, the liquid refrigerant may be further cooled to a greater extent below the boiling point. Such a further cooling is referred to as sub-cooling.

Sub-cooling may increase overall thermodynamic efficiency by presenting an even colder refrigerant to the evaporator, where warm air received from an interior space transfers heat to the air conditioning system. Thus, providing sub-cooling may promote a greater extraction of heat from the warm air received from the interior space compared to a refrigerant that is not sub-cooled or is at a temperature substantially at or close to the boiling point.

To promote sub-cooling, the sub-cooling conduit 14 may include a length of tubing, which may be a single straight length of tubing or which may include a plurality of undulations, or undulating turns of tubing, similar to the condenser 12. In certain embodiments, the sub-cooling conduit 14 may be formed as a miniaturized or smaller version of the condenser 12 or may have a form or geometry different from that of the condenser 12. The tubing of the sub-cooling conduit 14 may be formed of the same or similar material as the condenser 12 or as a different material. The sub-cooling conduit 14 may include metal or alloy tubing. The tubing may include copper or be formed of copper.

A cross-section of the metal or alloy tubing may define a curved, polygonal, rounded polygonal, or a compound periphery. The cross-section may be circular. The cross-section may be any suitable size, shape, or configuration.

In some embodiments, the sub-cooling conduit 14 may be a portion of the condenser 12 itself, for example, a length of tubing that extends beyond a length sufficient for condensation. The additional length may provide additional heat transfer surface to promote cooling lower than the boiling/condensation point. Thus, in certain embodiments, the air conditioning system 10 may not include a separate sub-cooling conduit 14, with a portion of the condenser 12 itself acting as a sub-cooling conduit 14.

The sub-cooling conduit 14 may be held in place by a frame or a stand and may be offset from a bottom surface or may be in contact with a bottom surface of the base pan 16. In certain embodiments, the sub-cooling conduit 14 is positioned to be at least partially immersed in the condensate in the base pan 16. For example, a bottom portion 15 of the sub-cooling conduit 14 may be immersed in the condensate in the base pan 16. Such immersion may provide further heat transfer between the sub-cooling conduit 14 and the condensate in the base pan 16.

In certain embodiments, the sub-cooling conduit 14 extends along a conduit axis C. The conduit axis C may be substantially transverse to the flow direction F (in FIG. 1B, the flow direction points inward from the condenser fan 18 toward the condenser 12, which is transverse to the axis C). In some embodiments, the conduit axis C extends along a direction that is vertical relative to gravity. Providing a generally vertical conduit axis may promote the flow of condensate from the sub-cooling conduit 14 (whether initially formed on conduit 14 or transmitted as droplets 26) back to the base pan 16. In certain embodiments, the sub-cooling conduit 14 is positioned above at least a portion of the base pan 16 to cause at least a volume of the condensate to fall from the sub-cooling conduit 14 into the base pan 16.

While the refrigerant flowing internally within tubing or flow paths along the air conditioning system 10 changes stages between gaseous and liquid form, external moisture present in the ambient air diffusing or percolating through the air conditioning system 10 may also condense in response to a reduction in temperature near certain components of the air conditioning system 10. For example, the refrigerant in a section of the condenser 12 or the sub-cooling conduit 14 or any other component of the air conditioning system 10 incidentally may be cooled to a temperature sufficient to cause condensation of moisture present in the ambient air. This condensed moisture may initially deposit and collect on surfaces of the components of the air conditioning system 10 and eventually form a film, sheets, droplets, or some other flowing or dripping liquid condensate.

The base pan 16 is configured to collect external condensate formed from ambient moisture as a volume of the condensate 24. The base pan 16 may include or be formed of a metal, an alloy, a plastic, or any other suitable material or combinations of materials. The base pan 16 may define a rim sufficiently high to collect a predetermined volume of the condensate. The base pan 16 may have any suitable shape, for example, curved or polygonal. For example, the base pan 16 may be in the form of a rounded square or a rounded rectangle. The base pan 16 may include an overflow outlet at a particular height, which may be connected to an overflow tube, which may lead to a drain or the like. Thus, excess condensate may be directed through the overflow tube to a predetermined outlet. The base pan 16 may be configured to collect and maintain at least a threshold amount of moisture after a predetermined cycle time of the air conditioning system 10.

In addition to blowing air toward the condenser 12, the condenser fan 18 may also be used to direct a portion or a volume of the condensate 24 from the base pan 16 (or the condensate dripping toward the base pan 16) toward the sub-cooling conduit 14. For example, the condenser fan 18 may rotate at a rate (rotations per minute) that causes droplets or mist 26 (shown in FIG. 1B) to be aerated or formed from condensate in the base pan 16. The aeration or droplet formation may be initiated by airflow from the condenser fan 18 or from contact between blades 28 of the condenser fan 18 and the condensate 24. For example, the blades 28 may contact a surface of the condensate 24 or enter a depth of the condensate 24 in the base pan 16, causing a motive force to be exerted on the condensate 24, which in turn may generate the droplets 26. In some instances, the blades 28 may include scoops or the like at their distal ends to further generate the droplets 26. The sub-cooling conduit 14 may be situated or oriented relative to the condenser fan 18, accounting for a direction of rotation R (marked by a curved arrow in FIG. 1B) of the condenser fan 18, such that the droplets 26 would generally be directed towards the sub-cooling conduit 14.

In certain embodiments, as noted above, the blades 28 of the condenser fan 18 may be provided with a plurality of buckets, scoops, indentations, ridges, or other suitable features to pick up volumes of water as the blades rotate. The plurality of buckets, scoops, indentations, ridges, or other suitable features may be configured to direct the droplets 26 towards the sub-cooling conduit 14.

While the droplets 26 have been described, it is understood that the droplets 26 may merge into a stream or that the condenser fan 18 may direct a semi-continuous or continuous stream of condensate 24 toward the sub-cooling conduit 14. In certain embodiments, the condenser fan 18 includes a slinger ring 29 or the like (shown in FIG. 1B) configured to contact and sling the volume of fluid toward the sub-cooling conduit 14. The slinger ring 29 may be formed of any suitable rigid, semi-rigid, or flexible material, for example, a metal, an alloy, a plastic, a ceramic, a fabric, a non-woven material, etc. The slinger ring 29 may have a substantially smooth surface, a roughened surface, or a textured surface. The slinger ring 29 may be provided with a plurality of buckets, scoops, indentations, ridges, or other suitable features to pick up volumes of water as the slinger ring 29 rotates and direct the water towards the sub-cooling conduit 14. The slinger ring 29 may be secured to the blades 28, for example, by a friction fit, an interference fit, an adhesive, a weld, a fastener, a clip, or any suitable fastening mechanism such that the slinger ring 29 rotates with the blades 28.

Thus, the condenser fan 18 may be positioned relative to the base pan 16 to cause the condenser fan 18 to direct a volume of the condensate 24 from the base pan 16 onto the sub-cooling conduit 14. The condenser fan 18 may be any suitable size, shape, or configuration.

The condensate 24 may promote sub-cooling within the sub-cooling conduit 14. For example, instead of only providing sub-cooling by dissipating heat from the sub-cooling conduit 14 to ambient air, a greater extent of heat dissipation may be provided by the droplets 26 or another volume or portion of the condensate 24 contacting the sub-cooling 14.

Various components of the air conditioning system 10 may be housed or shielded by a housing 30. The housing 30 may be formed by a material that is the same as or similar to that described with reference to the base pan 16. The housing 30 may be continuous or perforated. In certain embodiments, a bottom portion of the housing 30 itself may define the base pan 16. Thus, a separate base pan 16 may not be present. In some embodiments, a liner (for example, a plastic or waterproof liner) may be provided on a bottom surface of the housing 30, forming a bottom corresponding to the base pan 16.

In certain embodiments, the base pan 16 rests on a bottom surface of the housing 30. In other embodiments, the base pan 16 may be spaced from the bottom surface of the housing 30, for example, by a stand, a frame, or a spacer. The base pan 16 may be any suitable size, shape, or configuration.

The housing 30 may define opposed sidewalls 32 and 34. The base pan 16 may extends in a direction B between the opposed sidewalls 32 and 34. In certain embodiments, the conduit axis C may extend along a direction substantially parallel to a sidewall (32 or 34) of the opposed sidewalls. In some instances, the sub-cooling conduit 14 may be between the condenser fan 18 and the sidewall 32 (or 34).

The air conditioning system 10 may include further components to complete the cooling cycle. For example, the system 10 may further include a compressor 36 fluidically coupled to the condenser 12 and configured to compress expanded gas into compressed gas. The compressor 36 may supply the compressed gas to the inlet 20 of the condenser 12. In some instances, at least one of the condenser 12 or the condenser fan 18 may be positioned between the sub-cooling conduit 14 and the compressor 36.

The air conditioning system 10 may further include an evaporator coil 38 coupled to the condenser 12 (for example, via the sub-cooling conduit 14). The evaporator coil 38 may be configured to receive liquid refrigerant from the condenser 12. For example, liquid refrigerant from the outlet 22 of the condenser 12 may be sub-cooled in the sub-cooling conduit 14 and then transported to the evaporator coil 38. The evaporator coil may be generally formed in a manner similar to that described with reference to the condenser 12, but provide the opposite function (expanding and heating liquid refrigerant into gaseous refrigerant. The sub-cooling conduit 14 may thus be between the condenser 12 and the evaporator coil 38. In this manner, the condenser 12 and the evaporator coil 38 each act as a heat transfer coil or the like.

The air conditioning system 10 may further include an expansion valve 40 between the condenser 12 and the evaporator coil 38. The expansion valve 40 may control and facilitate evaporation of liquid refrigerant received from the condenser 12 into a gaseous state.

The air conditioning system 10 may be implemented in any suitable appliance. For example, a standalone air conditioning unit or a room or window air conditioning unit may include the air conditioning system 10. A split HVAC system may also include the air conditioning system 10. For example, an outdoor unit of a split HVAC system may similarly use the condenser fan 18 to sling or splash condensate from the base pan 16 to the sub-cooling coil in the outdoor unit.

In certain embodiments, the present disclosure describes a method of sub-cooling refrigerant for air conditioning. The method includes condensing, in a condenser, gaseous refrigerant into liquid refrigerant. The method further includes collecting external condensate formed from ambient moisture in a base pan. The method further includes directing, by a condenser fan, a volume of condensate from the base pan onto a sub-cooling conduit fluidically coupled to the condenser. The method further includes sub-cooling the liquid refrigerant in the sub-cooling conduit.

In certain embodiments, the present disclosure describes a method of assembling an air conditioning unit. The method may include coupling a sub-cooling conduit to a condenser. The condenser may be configured to condense gaseous refrigerant into liquid refrigerant. The sub-cooling conduit may be configured to receive and sub-cool the liquid refrigerant. The method further includes securing a base pan relative to the condenser to allow the base pan to collect external condensate formed from ambient moisture below the condenser. The method may further include positioning and securing a condenser fan to cause the condenser fan to blow air in a flow direction toward the condenser and to direct a volume of condensate from the base pan onto the sub-cooling conduit.

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

Modifications and variations of the assemblies, devices, and methods described herein will be obvious to those skilled in the art from the foregoing detailed description. Such modifications and variations are intended to come within the scope of the appended claims.

That which is claimed is:

1. An air conditioning system comprising:
a condenser configured to condense gaseous refrigerant into liquid refrigerant;
a sub-cooling conduit fluidically coupled to the condenser and configured to receive and sub-cool the liquid refrigerant;
a base pan configured to collect condensate; and
a condenser fan configured to blow air in a flow direction toward the condenser,
wherein the condenser fan is positioned relative to the base pan to cause the condenser fan to direct a volume of condensate from the base pan onto the sub-cooling conduit.

2. The air conditioning system of claim 1, wherein the sub-cooling conduit extends along a conduit axis that is substantially transverse to the flow direction.

3. The air conditioning system of claim 1, wherein the conduit axis extends along a direction that is vertical relative to gravity.

4. The air conditioning system of claim 1, further comprising a housing defining opposed sidewalls, wherein the base pan extends in a direction between the opposed sidewalls.

5. The air conditioning system of claim 4, wherein the conduit axis extends along a direction substantially parallel to a sidewall of the opposed sidewalls.

6. The air conditioning system of claim 5, wherein the sub-cooling conduit is between the condenser fan and the sidewall.

7. The air conditioning system of claim 6, wherein a bottom portion of the housing defines the base pan.

8. The air conditioning system of claim 7, wherein the base pan is spaced from a bottom surface of the housing.

9. The air conditioning system of claim 7, wherein the base pan rests on a bottom surface of the housing.

10. The air conditioning system of claim 1, wherein the sub-cooling conduit comprises a plurality of undulations.

11. The air conditioning system of claim 1, wherein the sub-cooling conduit is positioned to be partially immersed in condensate in the base pan.

12. The air conditioning system of claim 1, wherein the sub-cooling conduit is positioned above at least a portion of the base pan to cause at least a volume of condensate to fall from the sub-cooling conduit into the base pan.

13. The air conditioning system of claim 1, wherein the condenser fan comprises a slinger ring configured to contact and sling the volume of fluid toward the sub-cooling conduit.

14. The air conditioning system of claim 1, further comprising a compressor fluidically coupled to the condenser and configured to compress expanded gas into compressed gas.

15. The air conditioning system of claim 14, wherein at least one of the condenser or the condenser fan is positioned between the sub-cooling conduit and the compressor.

16. The air conditioning system of claim 1, further comprising an evaporator coil coupled to the condenser and configured to receive liquid refrigerant from the condenser and expand the liquid refrigerant into a gaseous refrigerant, wherein the sub-cooling conduit is between the condenser and the evaporator coil.

17. The air conditioning system of claim 1, wherein the sub-cooling conduit extends along a conduit axis, and wherein the conduit axis extends along a direction that is substantially vertical relative to gravity.

18. The air conditioning system of claim 1, wherein the sub-cooling conduit is positioned above at least a portion of the base pan to cause at least a volume of the condensate to fall from the sub-cooling conduit into the base pan.

19. A method of sub-cooling refrigerant for air conditioning, the method comprising:
condensing, in a condenser, gaseous refrigerant into liquid refrigerant;
collecting condensate formed from ambient moisture in a base pan;
blowing, by the condenser fan, a volume of air toward the condenser;
directing, by the condenser fan, a volume of condensate from the base pan onto a sub-cooling conduit fluidically coupled to the condenser; and
sub-cooling the liquid refrigerant received from the condenser in the sub-cooling conduit.

20. An air conditioning system comprising:
a sub-cooling conduit;
a base pan configured to collect condensate; and
a slinger ring configured to contact and sling the condensate towards the sub-cooling conduit.
